(19) United States
(12) Patent Application Publication
(10) Pub. No.: US 2013/0064340 A1
(43) Pub. Date: Mar. 14, 2013

(54) Method and System to Remove Debris from a Fusion Reactor Chamber

(71) Applicants: Jeffery F. Latkowski, Mercer Island, WA (US); Andrew W. Cook, Brentwood, CA (US); Gregory A. Moses, Madison, WI (US)

(72) Inventors: Jeffery F. Latkowski, Mercer Island, WA (US); Andrew W. Cook, Brentwood, CA (US); Gregory A. Moses, Madison, WI (US)

(73) Assignee: Lawrence Livermore National Security, LLC, Livermore, CA (US)

(21) Appl. No.: 13/614,831

(22) Filed: Sep. 13, 2012

Related U.S. Application Data
(60) Provisional application No. 61/534,315, filed on Sep. 13, 2011.

(51) Int. Cl. G21B 1/11

(52) U.S. Cl. 376/146

(57) ABSTRACT

A method of removing a debris cloud from a fusion reactor includes injecting a fluid jet into the fusion reactor at a first velocity and thereafter, injecting a fusion target into the fusion reactor at a second velocity. The method also includes irradiating the fusion target with laser light and creating a fusion event. The method further includes forming a debris cloud in a vicinity of the fusion event and removing the debris cloud from the fusion reactor. The fluid jet applies a motive force to the debris cloud.

### REFERENCE TO RELATED APPLICATIONS

This application claims priority from and the benefit of U.S. Provisional Application No. 61/534,315, filed Sep. 13, 2011, entitled “Method and System to Remove Debris from a Fusion Reactor Chamber,” which is incorporated herein by reference in its entirety. In addition, this application is related to U.S. Provisional Application No. 61/382,386, filed Sep. 13, 2010, entitled “Method and System to Remove Debris from a Fusion Reactor Chamber.”

### STATEMENT AS TO RIGHTS TO INVENTIONS MADE UNDER FEDERALLY SPONSORED RESEARCH AND DEVELOPMENT

The United States Government has rights in this invention pursuant to Contract No. DE-AC52-07NA27344 between the United States Department of Energy and Lawrence Livermore National Security, LLC, for the operation of Lawrence Livermore National Security.

### BACKGROUND OF THE INVENTION

Projections by the Energy Information Agency and current Intergovernmental Panel on Climate Change (IPCC) scenarios expect worldwide electric power demand to double from its current level of about 2 terawatts electrical power (TWe) to 4 TWe by 2030, and could reach 8-10 TWe by 2100. They also expect that for the next 30 to 50 years, the bulk of the demand of electricity production will be provided by fossil fuels, typically coal and natural gas. Coal supplies 41% of the world's electric energy today, and is expected to supply 45% by 2030. In addition, the most recent report from the IPCC has placed the likelihood that man-made sources of CO2 emissions into the atmosphere are having a significant effect on the climate of planet earth at 90%. “Business as usual” baseline scenarios show that CO2 emissions could be almost two and a half times the current level by 2050. More than ever before, new technologies and alternative sources of energy are essential to meet the increasing energy demand in both the developed and the developing worlds, while attempting to stabilize and reduce the concentration of CO2 in the atmosphere and mitigate the concomitant climate change.

Nuclear energy, a non-carbon emitting energy source, has been a key component of the world's energy production since the 1950's, and currently accounts for about 16% of the world's electricity production, a fraction that could—in principle—be increased. Several factors, however, make its long-term sustainability difficult. These concerns include the risk of proliferation of nuclear materials and technologies resulting from the nuclear fuel cycle; the generation of long-lived radioactive nuclear waste requiring burial in deep geological repositories; the current reliance on the once through, open nuclear fuel cycle; and the availability of low cost, low carbon footprint uranium ore. In the United States alone, nuclear reactors have already generated more than 55,000 metric tons (MT) of spent nuclear fuel (SNF). In the near future, we will have enough spent nuclear fuel to fill the Yucca Mountain geological waste repository to its legislated limit of 70,000 MT.

Fusion is an attractive energy option for future power generation, with two main approaches to fusion power plants now being developed. In a first approach, Inertial Confinement Fusion (ICF) uses lasers, heavy ion beams, or pulsed power to rapidly compress capsules containing a mixture of deuterium (D) and tritium (T). As the capsule radius decreases and the DT gas density and temperature increase, DT fusion reactions are initiated in a small spot in the center of the compressed capsule. These DT fusion reactions generate both alpha particles and 14.1 MeV neutrons. A fusion burn front propagates from the spot, generating significant energy gain. A second approach, Magnetic Fusion Energy (MFE), uses powerful magnetic fields to confine a DT plasma and to generate the conditions required to sustain a burning plasma and generate energy gain.

Important technology for ICF is being developed primarily at the National Ignition Facility (NIF) at Lawrence Livermore National Laboratory (LLNL), assignee of this invention, in Livermore, Calif. There, a laser-based inertial confinement fusion project designed to achieve thermonuclear fusion ignition and burn utilizes laser energies of 1 to 1.3 MJ. Fusion yields of the order of 10 to 20 MJ are expected. Fusion yields in excess of 200 MJ are expected to be required in central hot spot fusion geometry if fusion technology, by itself, were to be used for cost effective power generation. Thus, significant technical challenges remain to achieve an economy powered by pure ICF energy.

### SUMMARY OF THE INVENTION

According to embodiments of the present invention, techniques related to the removal of debris clouds from fusion reaction chambers are provided. More particularly, embodiments of the present invention relate to methods and systems for passive and forced advection of debris clouds from fusion reaction chambers. In a specific embodiment, a fluid jet and a fusion target immersed in the fluid jet are injected into a fusion reaction chamber. The fluid jet provides a motive force to assist in the removal of the debris cloud produced by the fusion event from the fusion reaction chamber.

According to an embodiment of the present invention, a method of advecting a debris cloud from a fusion reactor is provided. The method includes injecting a fusion target into the fusion reactor at a predetermined velocity, irradiating the fusion target with laser light, and creating a fusion event. The method also includes forming a debris cloud in a vicinity of the fusion event and advecting the debris cloud from the fusion reactor at a velocity approximately equal to the predetermined velocity.

According to another embodiment of the present invention a method of removing a debris cloud from a fusion reactor is provided. The method includes injecting a fluid jet into the fusion reactor at a first velocity and thereafter, injecting a fusion target into the fusion reactor at a second velocity. The method also includes irradiating the fusion target with laser light and creating a fusion event. The method further includes forming a debris cloud in a vicinity of the fusion event and removing the debris cloud from the fusion reactor. The fluid jet applies a motive force to the debris cloud.

According to a specific embodiment of the present invention, a fusion reaction system is provided. The fusion reaction system includes a fusion reaction chamber including laser ports, an injection port, and an exit port. The fusion reaction system also includes a fusion target injection system operable to launch a fusion target into the fusion reaction chamber through the injection port and a laser system operable to direct laser beams into the fusion reaction chamber through the laser ports. The fusion reaction system further includes a fusion region disposed inside the fusion reaction chamber and operable to support a fusion event. A debris cloud produced by the fusion event exits the fusion reaction chamber through the exit port. In some embodiments, the fusion reaction system additionally includes a fluid jet inlet and a fluid jet system operable to inject a fluid jet into the fusion reaction chamber through the fluid jet inlet.

Numerous benefits are achieved by way of the present invention over conventional techniques. For example, embodiments of the present invention provide methods and systems suitable for the removal of debris from ICF gas-filled reactor chambers. The systems described herein are applicable to fusion reactors useful in producing electrical power. A benefit provided by embodiments of the present invention is that debris can be removed from the fusion reactor chamber without clearing and refilling the chamber. Because chamber clearing typically requires large open solid angle fractions and costly, space-intensive pumping and recycling systems, embodiments of the present invention positively impact chamber design and cost. Additionally, embodiments of the present invention enable reductions in or elimination of high gas exchange rates, which can be required to clear significant fractions of the chamber using conventional approaches. High gas exchange rates can result in turbulence and density gradients inside the chamber. These and other embodiments of the invention along with many of its advantages and features are described in more detail in conjunction with the text below and attached figures.

### BRIEF DESCRIPTION OF THE DRAWINGS

FIG. 1 is a simplified schematic diagram of a LIFE reaction chamber according to an embodiment of the present invention;

FIG. 2 is a simplified schematic diagram of a fusion reaction chamber according to an embodiment of the present invention;

FIG. 3 is a simplified schematic diagram of the fusion reaction chamber illustrated in FIG. 2 at the time of fusion ignition;

FIG. 4 is a simplified schematic diagram of the fusion reaction chamber illustrated in FIG. 2 showing plasma cooling and shock wave dissipation;

FIG. 5 is a simplified schematic diagram of the fusion reaction chamber illustrated in FIG. 2 showing a quiescent environment prior to the next fusion event;

FIG. 6 is a simplified schematic diagram of a fusion reaction chamber including inlet ports for forced advection according to an embodiment of the present invention;

FIG. 7A-7D are screen shots illustrating propagation of a debris cloud, Marshak waves, and shock waves following the fusion event illustrated in FIG. 3;

FIG. 8 is a simplified schematic diagram illustrating how one or more jets can assist a debris advection process according to an embodiment of the present invention;

FIG. 9 is an image illustrating a cool jet injected into a hot gas environment according to an embodiment of the present invention;

FIG. 10 is a simplified flowchart illustrating a method of advecting a debris cloud from a fusion reactor according to an embodiment of the present invention; and

FIG. 11 is a simplified flowchart illustrating a method of removing a debris cloud from a fusion reactor according to another embodiment of the present invention.

### DETAILED DESCRIPTION OF SPECIFIC EMBODIMENTS

Embodiments of the present invention relate to fusion reaction chambers. Embodiments of the present invention are applicable to energy systems including, but are not limited to, a Laser Inertial-confinement Fusion Energy (LIFE) engine, hybrid fusion-fission systems such as a hybrid fusion-fission LIFE system, a generation IV reactor, an integral fast reactor, magnetic confinement fusion energy (MFE) systems, accelerator driven systems and others. In some embodiments, the energy system is a hybrid version of the LIFE engine, a hybrid fusion-fission LIFE system, such as described in International Patent Application No. PCT/US2008/011335, filed Sep. 30, 2008, titled “Control of a Laser Inertial Confinement Fusion-Fission Power Plant”, the disclosure of which is hereby incorporated by reference in its entirety for all purposes.

According to an embodiment of the present invention, methods and systems are provided for removing target debris (in an alternative embodiment, ionic debris) from a gas-filled ICF reactor chamber between shots at high repetition rate while protecting the cryogenic target from heat transfer from hot chamber gases. In ICF systems operating at high repetition rates (e.g., 13 Hz), removal of debris from the reaction chamber improves system performance since such debris can interfere with beam propagation, target injection, first-wall performance, and the like. One of ordinary skill in the art would recognize many variations, modifications, and alternatives.

Current ICF reaction chambers are operated at low repetition rates. As designs for high repetition rate systems have been developed, conventional approaches involved clearing and refilling the chamber after each fusion event. In contrast with these conventional approaches, embodiments of the present invention enable debris removal without clearing and refilling the chamber using either passive advection, forced advection, or a combination thereof. The debris that is removed from the fusion reaction chamber can include metals, carbon, other target materials, and the like.

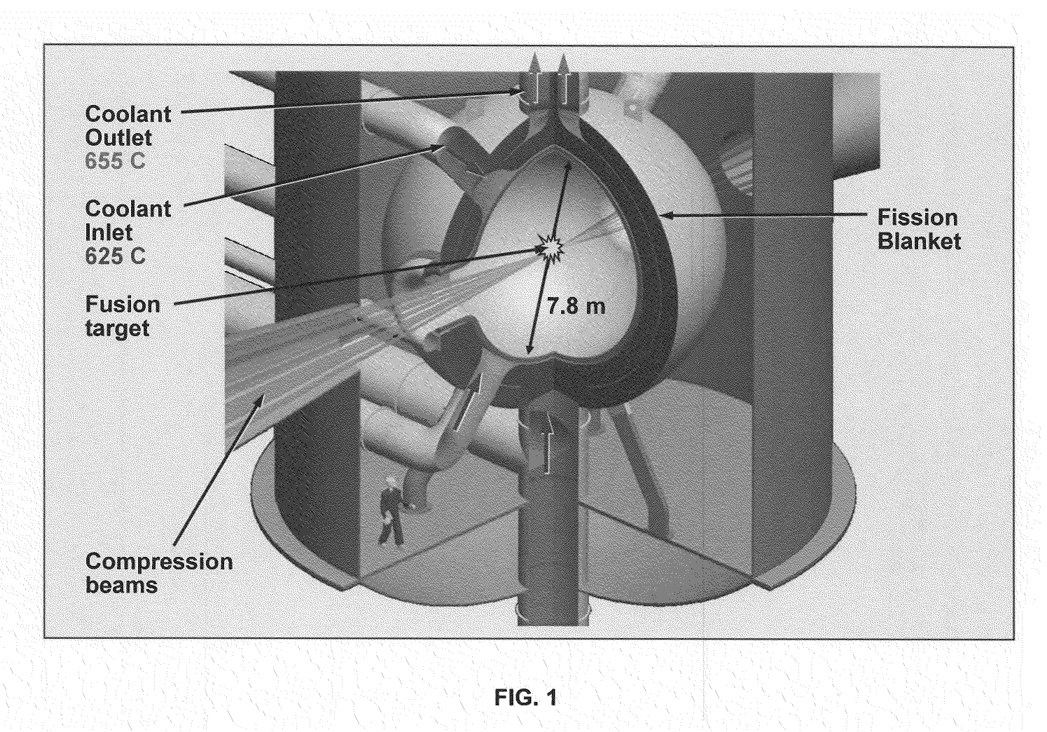

FIG. 1 is a simplified schematic diagram of a fusion reaction chamber according to an embodiment of the present invention. The fusion reaction chamber illustrated in FIG. 1 is not intended to limit the scope of embodiments of the present invention and is merely presented as an example chamber in which embodiments of the present invention can be implemented. Other chamber designs are also included within the scope of the present invention. The fusion reaction chamber, which can be a fast ignition fusion chamber, receives laser compression beams and ignition beams. The fusion target is illustrated in the center of the chamber and a fission blanket surrounds the chamber. The spherical chamber configuration illustrated in FIG. 1 enables uniform irradiation of the fission fuel in the fission blanket and uniform radiation damage to the chamber walls before replacement, thereby maximizing material utilization. Preferably, oxide dispersion strengthened ferritic steels are used for construction of the spherical engine chamber, with a solid first wall consisting of tungsten or tungsten-carbide armor. Such steel is less sensitive to displacement from lattice sites by neutron bombardment.

The chamber includes a layer of beryllium or lead as a neutron moderator and multiplier. A radial flow high-temperature lithium-containing coolant system, for example, using flibe (2LiF+BeF₂) or flinak (LiF+NaF+KF), includes multiple entrance ports, others not shown, as well as one or more exit ports. The coolant removes heat from the fission blanket and transports the heat to a Brayton energy conversion system. A high-rate fusion target fabrication and injection system, with target tracking and laser firing, introduces targets into the chamber at a high repetition rate. Additional description related to fusion reaction chambers are their operation is found in International Patent Application No. PCT/US2008/011335, incorporate by reference above.

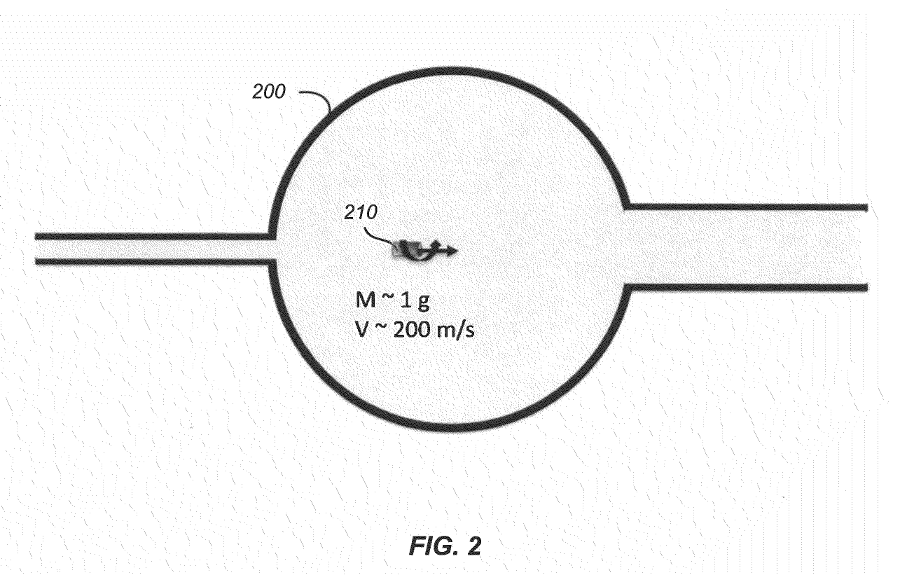

FIG. 2 is a simplified schematic diagram of a fusion reaction chamber according to an embodiment of the present invention. A fusion target 210 is introduced into the fusion reaction chamber 200 by a target delivery system (not shown). In the illustrated embodiment, the fusion target is a rifled (i.e., rotating) hohlraum/capsule assembly containing a deuterium tritium fuel. As an example, the fusion targets can be cylindrical, have a mass of about 1 gram and be injected into the chamber at a velocity of about 200 m/s and rotates due to the rifling. The fusion target 210 is illustrated at a position to the left of the chamber center, moving toward the chamber center, and prior to the fusion event. It should be noted that the fusion target 210 is injected in this embodiment through a small tube located on the left side of the fusion reaction chamber.

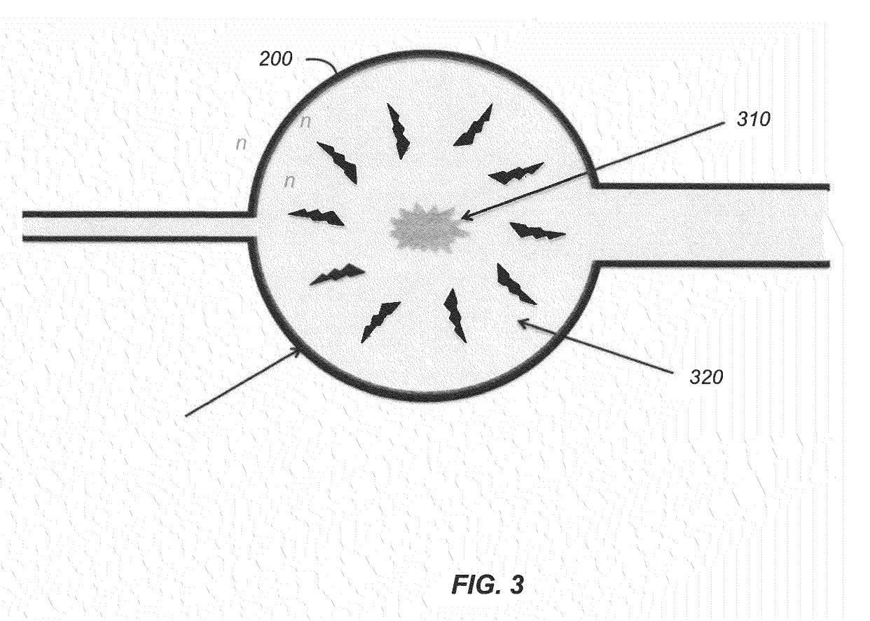

FIG. 3 is a simplified schematic diagram of the fusion reaction chamber illustrated in FIG. 2 at the time of fusion ignition. FIG. 3 also shows attenuation by the chamber fill gas. The fusion target has been imploded with laser-driven x-rays and has produced an energy gain of about 50-100 (fusion energy out divided by laser energy in). The majority of the energy (˜80%) is emitted in the form of high-energy neutrons (represented by “n”), which move outward radially and are not significantly attenuated in the chamber fill gas.

In addition to the energy emitted in the form of high-energy neutrons, energy is emitted in the form of x-rays and ions. A significant percentage of the x-ray energy emitted by the fusing target (e.g., 80-90%) is deposited in the fill gas present in the chamber, contributing to Marshak waves and shock waves 320. A smaller percentage of the energy emitted in the form of x-rays from the fusing target (e.g., 10-20%) is deposited in the fill gas present in the chamber and in the first wall, creating a temperature spike. Thus, by deposition in the fill gas and the first wall, x-rays emitted by the fusion event (i.e., thermonuclear burn) are attenuated by the fill gas. Additional energy is present after the fusion event (˜10% of the energy) in the form of ionic debris, which stops within tens of centimeters of the center of the chamber. At the chamber gas densities utilized in one embodiment, this volume of chamber gas has a mass of 1 gram, similar to the mass of the original fusion target.

According to an embodiment of the present invention, the fusion reaction chamber 200 is filled with xenon gas or another noble gas at an atomic density of approximately 1×10¹⁶ cm⁻³ to 3×10¹⁶ cm⁻³. As described throughout the present specification, the fill gas present in the chamber absorbs a significant portion of the x-ray energy and prevents essentially all ions emitted from the targets from reaching the inner wall of the chamber. Thus, the ions emitted from the fusion target after the fusion event are illustrated as cloud 310 since they stop within several tens of centimeters from the chamber center. The ions in cloud 310 launch Marshak waves and shock waves 320 as discussed more fully below. Neutrons, illustrated by the symbol n, escape from the chamber without heating either the gas or the first wall.

The inventors have determined through computational fluid dynamics/hydrodynamic modeling of the fusion event and the resulting debris cloud that the presence of the gas in the fusion reaction chamber results in a debris cloud with a diameter that is just a fraction of the diameter of the fusion reaction chamber. Thus, initial concepts in which the debris from the fusion event was ejected toward and made contact with the first wall of the chamber have been modified as a result of the inventors' determination that the debris cloud is highly localized.

In conventional dry wall concepts for ICF, such as direct drive, the gas density in the fusion reaction chamber is maintained at a low density in order to range the particles out. The low density of gas results in a debris cloud that effectively fills the chamber, with the particles produced by the fusion event reaching the chamber walls. As a result of the large number of gas particles in the debris cloud, the mass of the debris cloud is typically orders of magnitude higher than the original mass of the fusion target. In such an environment, assuming that the fusion target is injected at a first velocity, the velocity of the debris cloud will be a second velocity much lower than the first velocity since momentum will be conserved. Thus, initial concepts included a substantially stationary debris cloud following the fusion event.

As illustrated in FIG. 3, the ions produced by the fusion event stop within a few tens of centimeters as they interact with the gas present in the chamber. In addition to the arresting of the expansion of the debris cloud 310, the mass of the debris cloud is similar to the mass of the original fusion target 210. Thus, in contrast with conventional concepts, embodiments of the present invention provide a gas density in the chamber such that the mass of the debris cloud is substantially matched to the mass of the original fusion target.

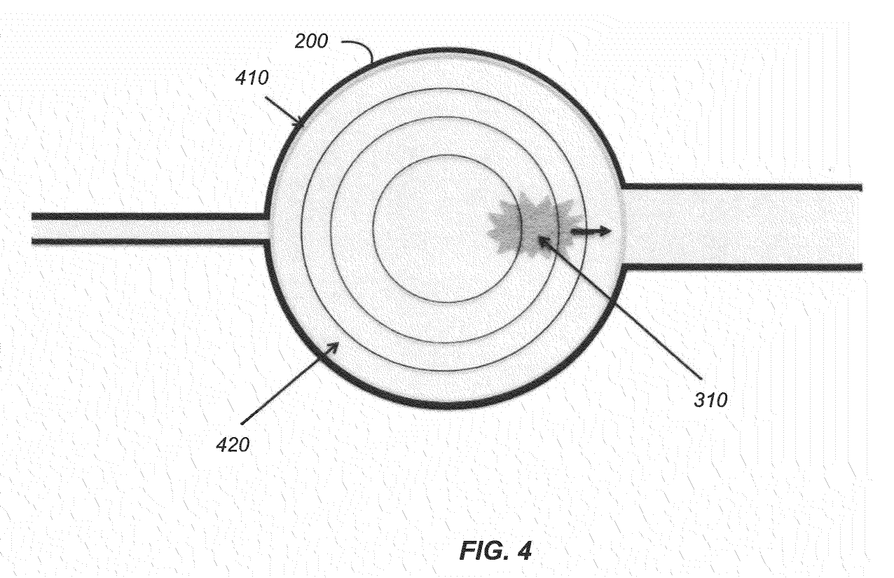

FIG. 4 is a simplified schematic diagram of the fusion reaction chamber illustrated in FIG. 2 showing plasma cooling and shock wave dissipation. As illustrated in FIG. 4, Marshak waves 410 hit the first wall at a few microseconds (e.g., ˜10 μs) and them reflect within the chamber. After the Marshak waves, shock waves hit the first wall at a few milliseconds (e.g., ˜10 ms). Plasma resulting from the fusion event recombines to a neutral gas (i.e., the chamber gas cools via radiation) with a few milliseconds, leaving the fill gas temperature at about ½ eV. Shock waves reflect from the chamber wall and reverberate in the chamber, losing energy to the chamber wall and the environment. In an embodiment, these shocks will pass through the debris cloud without significantly dispersing the cloud throughout the chamber. Thus, the plasma radiatively cools and the Marshak and shock waves dissipate within a few milliseconds. Using the fill gas essentially turns a nanosecond burst of x-rays into a millisecond burst of heat, which can be accommodated via thermal conduction in the tungsten of the first wall.

As discussed in relation to FIG. 3, the debris cloud 310 is characterized by a mass that is substantially matched (e.g., within an order of magnitude) to the original mass of the fusion target. Because of the conservation of momentum, the debris cloud advects away from the chamber center with substantially the original target velocity toward the chamber wall opposing the entry wall. As illustrated in FIG. 4, a dedicated exit port is provided in the chamber wall.

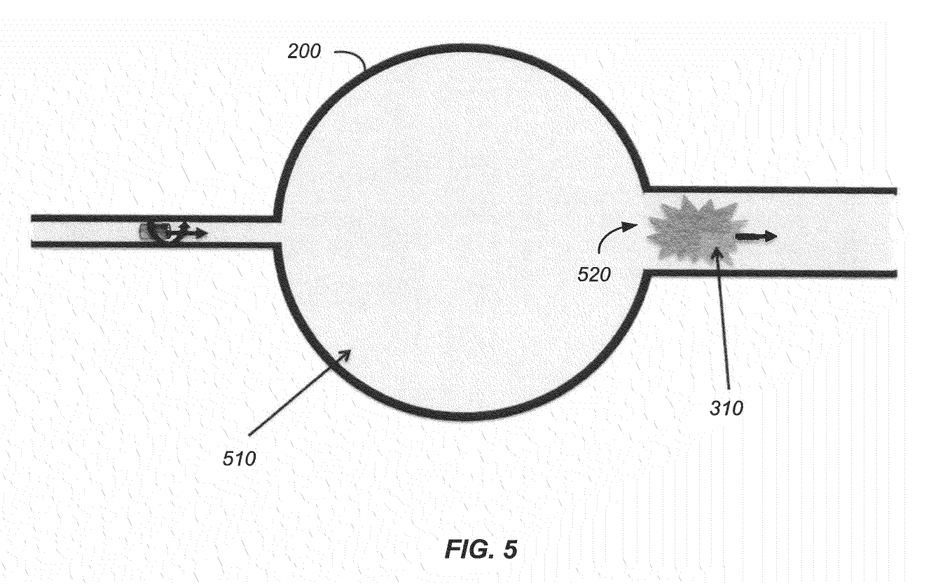

FIG. 5 is a simplified schematic diagram of the fusion reaction chamber illustrated in FIG. 2 showing a quiescent environment prior to the next fusion event. FIG. 5 illustrates the fusion reaction chamber at a time about 25 ms after the fusion event. The debris cloud 310 has exited the central portion of the chamber and entered the pumping system to be recovered. Shocks resulting from the fusion event have dissipated through interactions with the fill gas and the first wall and are illustrated by the lack of shock waves 510 in FIG. 5. The fill gas remains hot (˜½ eV) in this embodiment. In other embodiments in which radiative cooling mechanisms are provided, the fill gas can cool as appropriate to the particular application. Thus, after a few tens of milliseconds, the fill gas is quiescent and “clean.” Since, at a repetition rate of 13 Hz, the next target enters the fusion reaction chamber in 77 ms, the chamber presents the same environment for each subsequent fusion event.

Embodiments of the present invention utilizing passive debris advection take advantage of the initial target momentum to drive the debris from the fusion reaction chamber. The debris cloud 310 results because sufficient fill gas is maintained in the chamber to stop the hot target ions in a confined volume that is a fraction of the chamber size as illustrated in FIGS. 3-5. The expansion of the debris cloud is arrested through interactions between the energetic (also referred to as hot) ions and the fill gas atoms, resulting in a debris cloud that includes entrained chamber gas, ions, and/or target debris. Thus, embodiments of the present invention provide a localized debris cloud in contrast with conventional dry wall approaches.

Additionally, the gas density in the chamber is appropriate to produce a debris cloud having a mass approximately equal (e.g., within an order of magnitude) of the original fusion target mass. Thus, the initial target velocity is not lost, with the original momentum now operating on the debris cloud. For example, the system can be designed such that the ions stop by entraining roughly their mass of chamber gas. In this case, the debris cloud will advect passively along the original target injection trajectory with one-half of the initial target velocity, taking advantage of the conservation of momentum to clear debris from the reaction chamber. As illustrated in FIG. 5, an appropriately sized opening 520 in the chamber wall permits egress of the debris cloud before the next fusion target is injected into the fusion reaction chamber.

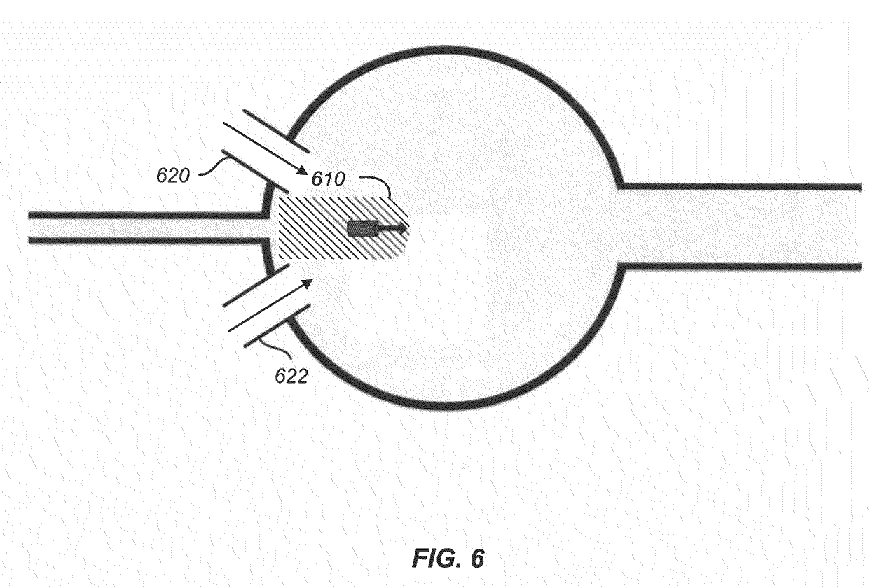

FIG. 6 is a simplified schematic diagram of a fusion reaction chamber including inlet ports for forced advection according to an embodiment of the present invention. In the embodiment illustrated in FIG. 6, passive advection is enhanced by providing flows through the chamber that enhance debris flushing. These flows can be provided or created in a number ways, including, without limitation, optimization of the chamber geometry, use of jets to push and guide the debris cloud, use of jets to compact the debris cloud or restore symmetry, and optimization of inlet and outlet flows to create streamlines favorable to flushing. For example, a jet (or multiple jets) along the target injection line is used in some embodiments to provide a back-pressure on the debris cloud to push it and any lingering trail of debris from the chamber. The jet also provides additional fill gas to the chamber, compensating for any protective fill gas leaving the chamber with the debris cloud. In a particular embodiment, the temperature of the fluid provided by the infill jet is lower than the ambient chamber fill gas, thereby serving to protect cryogenic targets from excessive heating during flight.

Referring to FIG. 6, a fluid jet 610 is provided by inlets 620 and 622. Although the inlets are illustrated astride the injection port for the fusion target, this is not required by embodiments of the present invention. In other embodiments, the inlets are integrated with the fusion target injection port to allow for flow of the forced advection fluid along a line collinear with the fusion target. One of ordinary skill in the art would recognize many variations, modifications, and alternatives.

Thus, embodiments of the present invention include forced advection systems in which the fluid associated with the infill jet provides a back pressure on the debris cloud to push the debris cloud, and any lingering trail of debris, from the chamber. In these embodiments utilizing forced advection, increases in the mass of the debris cloud in relation to the original fusion target mass, which result in the debris cloud moving at a lower velocity than the original fusion target velocity, can be compensated for using the fluid flow to push the debris cloud towards the egress opening.

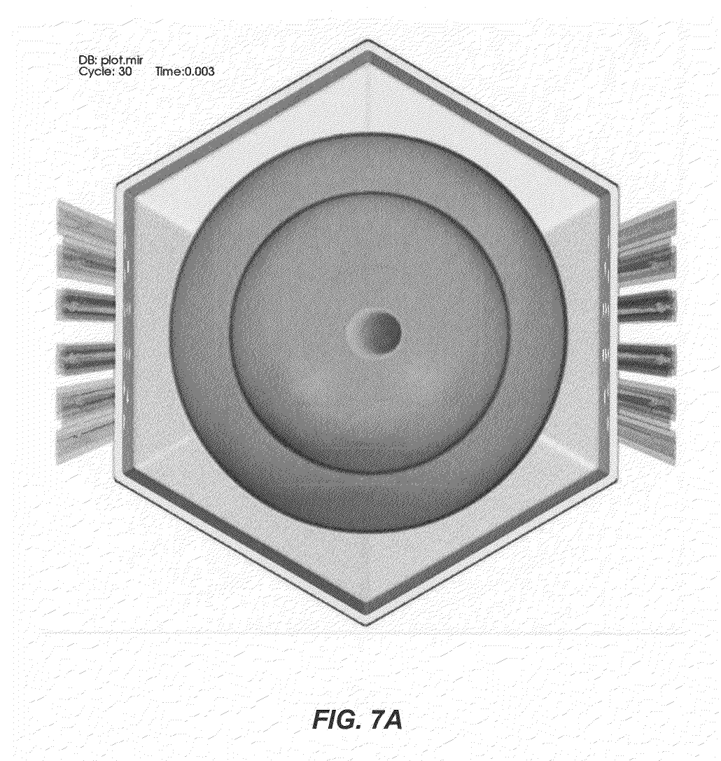

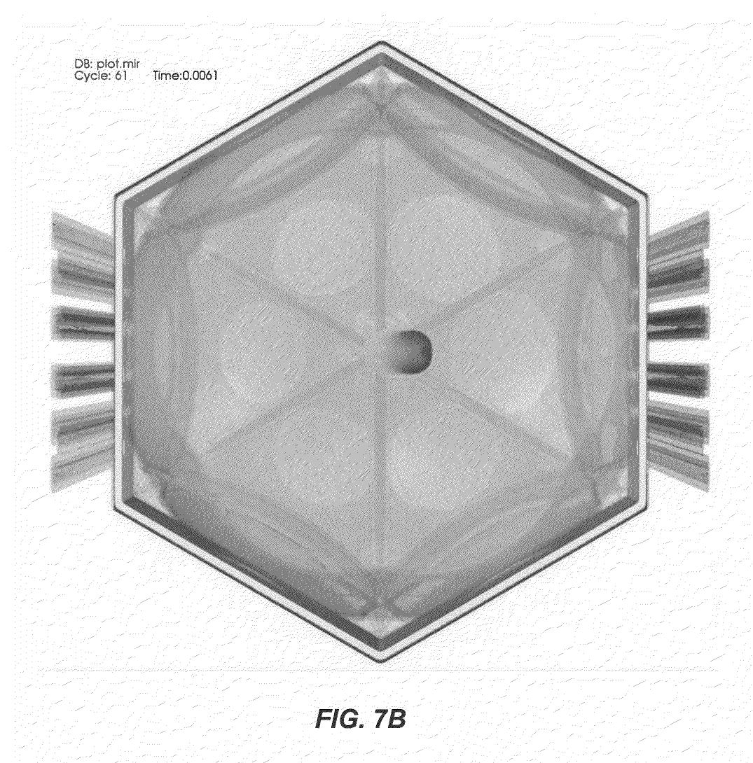

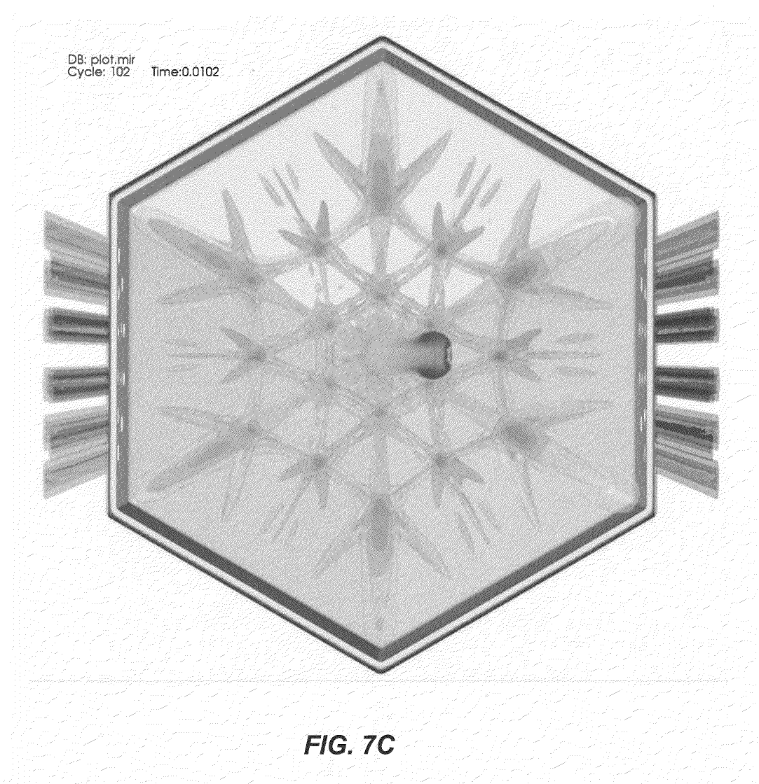

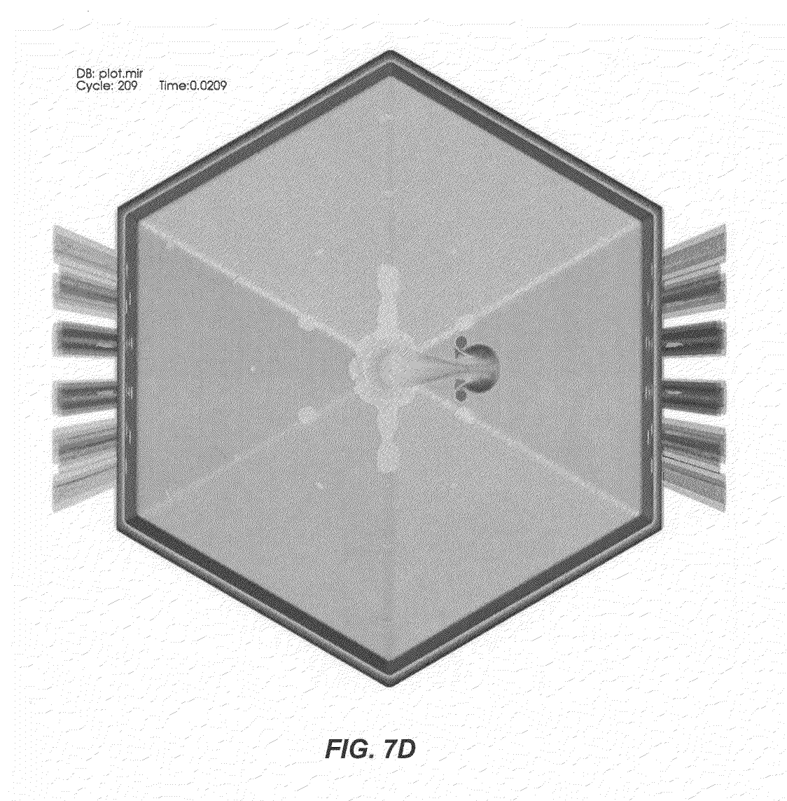

FIG. 7A-7D are screen shots illustrating propagation of a debris cloud, Marshak waves, and shock waves following the fusion event illustrated in FIG. 3. The images illustrated in FIGS. 7A-7D were produced using a hydrodynamic simulation of the fusion event illustrated in FIG. 3. The initial screen shot is at a time mark of 0.0003. In FIG. 7A, the shock waves and the Marshak waves are illustrated as propagating out from the center of the chamber, where the debris cloud is beginning to form. In some result, the Marshak waves and shock waves are indistinguishable.

FIG. 7B illustrates the Marshak waves and shock waves reflecting off the chamber walls at a time mark of 0.061. The propagation of the debris cloud to the right is evident in this figure in comparison to FIG. 7A. FIG. 7C illustrates reflection and interference of the Marshak and shock waves at a time mark of 0.102. The debris cloud has propagated farther to the right, with the largest density at the front of the cloud. As illustrated in FIG. 7C, the ions have stopped in the fill gas at a diameter of a few tens of centimeters. The momentum of the fusion target is conserved and the debris cloud moves to the right following the formation of the debris cloud.

As illustrated in FIG. 7D, the debris cloud continues to move toward the chamber exit after the chamber becomes quiescent. Although small eddies are evident peeling off from the debris cloud, the majority of the mass is still maintained in the debris cloud.

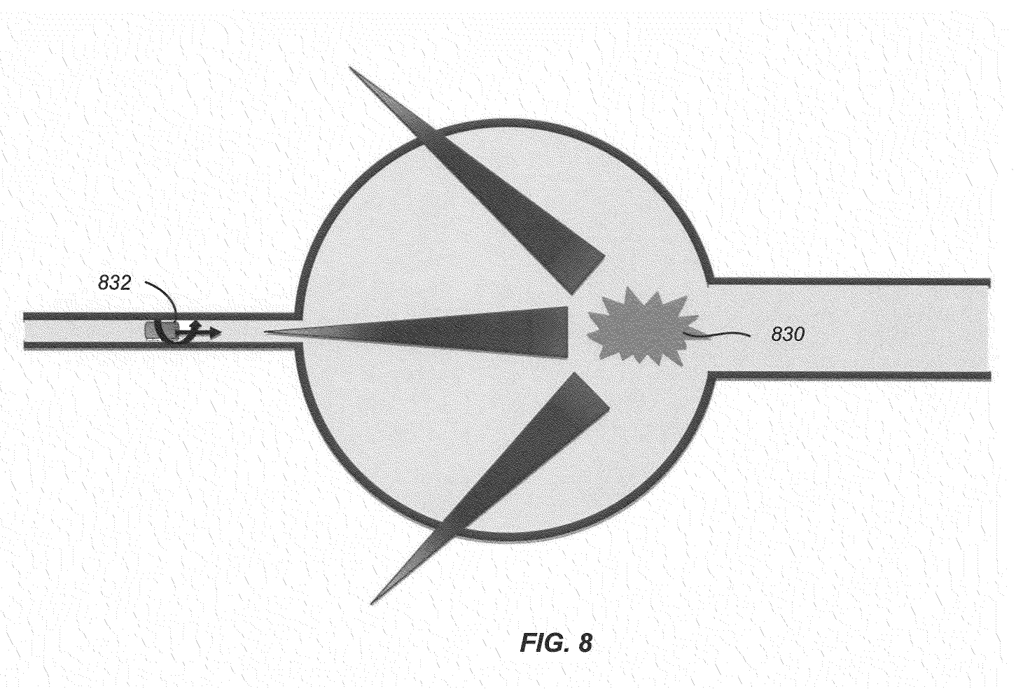

FIG. 8 is an image illustrating propagation of a debris cloud using forced advection according to an embodiment of the present invention. FIG. 8 is a simplified schematic diagram illustrating how one or more jets can assist a debris advection process according to an embodiment of the present invention. Thus, embodiments of the present invention provide for propagation of a debris cloud using forced advection. As illustrated in FIG. 8, one or more fluid jets provided from inlets (not shown) are used to help force debris from chamber. Debris 830 from the first target is illustrated near an exit port of the chamber. The next target 832 is illustrated as approaching the entry port of the chamber. Three fluid jets are illustrated in FIG. 8, but this is not required by embodiments of the present invention. In other embodiments, a different number of jets are utilized, for example, one jet, two jets, four jets, five jets, or the like. One of ordinary skill in the art would recognize many variations, modifications, and alternatives. According to some embodiments, the fluid jets is injected in such a manner that one or more of the jets propagate toward the chamber center.

In the embodiment illustrated in FIG. 6, the timing of the fluid injection and the fusion target injection are coordinated so that the fusion target is immersed in the fluid until a point just before the chamber center. The fusion target is thus free from the fluid at the chamber center in preparation for the fusion ignition, which can be beneficial so that laser beams used for compression do not have to traverse thermal gradients associated with the fluid jet. Referring to FIG. 8 the three illustrated fluid jets add momentum to the system, which assists in the debris removal process.

In addition to forced advection of the debris cloud from the chamber, one or more of the fluid jets can provide a cooling atmosphere for the fusion target. It is expected that the chamber environment will have a high steady state temperature on the order of 7000K-8000K. Such high temperatures present issues for injection of cryogenic targets. Since the central core of the fluid jet can be at a temperature in the range of 300K-1000K, it will provide a significant reduction in the level of conductive heating of the fusion target by the gas in the chamber.

For conductive heating, the conductive heat flux (q″) is equal to the heat transfer coefficient (h) times the temperature difference: q″=hΔT. Since the conductive heat flux is proportional to the temperature difference, the fluid jet, which is very cool in comparison to the chamber environment, will provide a greatly reduced ΔT for the fusion target and thereby reduced conductive heating. In the illustrated embodiment, the fusion target will be immersed in the fluid jet for the majority of the trajectory in the chamber. Since the front of the fluid jet bears the brunt of the convective heating, the fusion target is shielded by the fluid jet. Immersion in the fluid jet will also reduce the relative velocity between the fusion target and the surrounding environment, resulting in a reduction in the heat transfer coefficient as well, which is proportional to the velocity (∝ vel^{0.7}). Thus, by reductions in both the temperature difference and the heat transfer coefficient, the conductive heating of the fusion target is greatly reduced. Therefore, embodiments of the present invention provide methods and systems for forced advection that assist in removal of the debris cloud from the chamber as well as a reduction in heating of the fusion target due to immersion in the fluid jet.

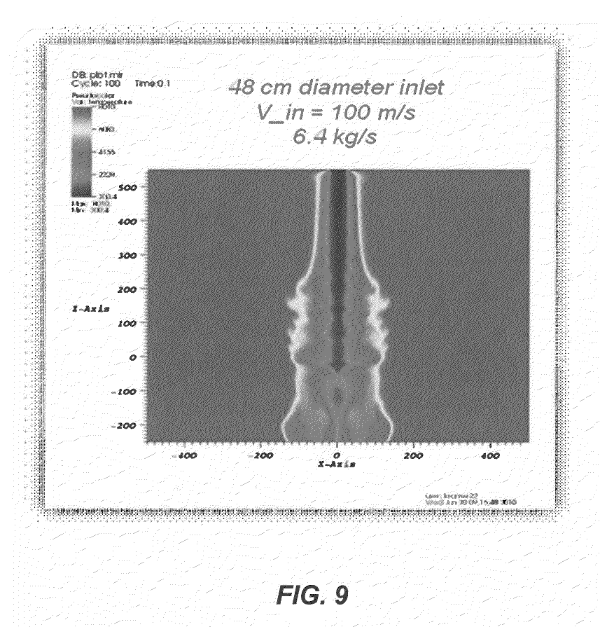

FIG. 9 is an image illustrating a cool jet injected into a hot gas environment according to an embodiment of the present invention. As illustrated in FIG. 9, a pathway of cool gas can protect the target from overheating during flight through the chamber. This pathway could be established via the injection of cool gas in a jet. If the velocity of the jet is approximately that of the target, then convective heat transfer between the target and gas is reduced or minimized. The jet can be optimized to provide the needed temperatures during flight as well as at target chamber center. The gas in the jet serves to refill chamber gas lost through pumping or venting. Because the jet travels along the target pathway, the jet can also be used to provide momentum to the debris ball, helping flush it from the chamber. Thus, the inventors have herein demonstrated the possibility of creating a clean, cold pathway of fluid to the chamber center.

The embodiments described above illustrate debris advection in a spherical chamber. However, it should be appreciated that optimization of the chamber shape can be utilized to enhance debris advection. For example, the wall and/or the debris port may be designed in a funnel-like shape to optimize or maximize flows in that direction. Additional jets other than that for the target injection may help to facilitate forced advection. These jets could be placed to help advect the debris cloud. The jets could also help restore symmetry to the debris cloud if the explosion and/or fluid mechanics cause it to become nonspherical or asymmetric, recompacting the tails and helping to move the debris from the chamber. Jets of different initial temperatures, orientations, shapes, and velocities can be used to provide different amounts of momentum to the cloud. Multiple jets of different orientation, shape, placement, initial temperature, and initial velocity may be utilized, with different configurations for different yields and targets designs. Warmer, slower jets can be used to dissipate more quickly. Non-jet inflows and the outflows from the system can be designed to establish streamlines that assist forced advection. One of ordinary skill in the art would recognize many variations, modifications, and alternatives.

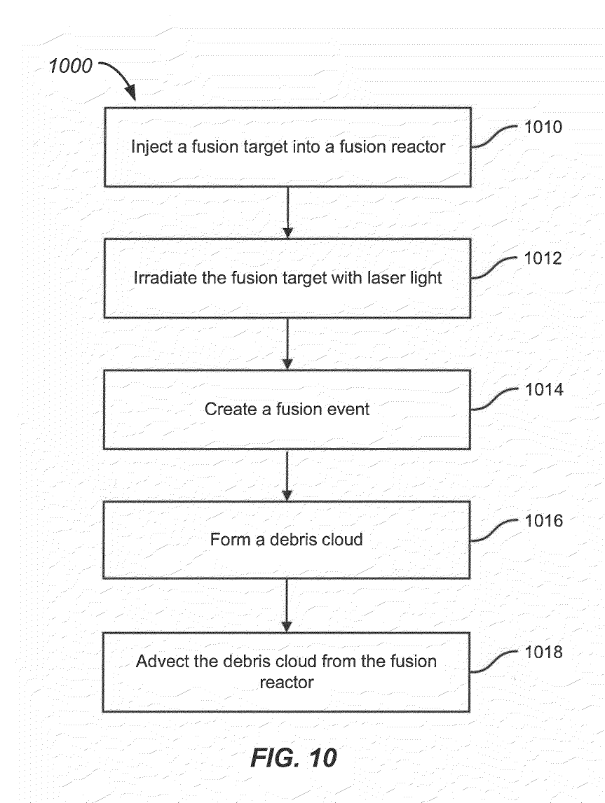

FIG. 10 is a simplified flowchart illustrating a method of advecting a debris cloud from a fusion reactor according to an embodiment of the present invention. The method illustrated in FIG. 10 can be referred to as passive advection since the debris cloud is removed from the fusion reactor as a result of conservation of momentum. The method 1000 includes injecting a fusion target into the fusion reactor at a predetermined velocity (1010), irradiating the fusion target with laser light (1012), and creating a fusion event (1014). In exemplary embodiments, the fusion target is a hohlraum containing fusion fuel. The hohlraum can be rifled in order to provide control over the flight path of the fusion target. Typically, the fusion target is injected into the fusion reactor with a velocity ranging from about 100 m/s to about 300 m/s, for example, 200 m/s. Other velocities are included within the scope of the present invention.

The method also includes forming a debris cloud in a vicinity of the fusion event (1016) and advecting the debris cloud from the fusion reactor at a velocity approximately equal to the predetermined velocity (1018). The fusion reactor includes a gas such as xenon and the debris cloud interacts with the gas present in the fusion reactor. In exemplary embodiments, the debris cloud is characterized by a diameter of less than 100 cm, for example, less than 50 cm. According to embodiments of the present invention, the velocity approximately equal to the predetermined velocity includes velocities less than the predetermined velocity, for example, between about 25% and 50% of the predetermined velocity. Thus, the term “approximately equal” is not intended to limit the velocity to within a few percent of the predetermined velocity, but can include velocities within an order of magnitude of the predetermined velocity. As described more fully throughout the present specification, the velocity of the debris cloud in passive advection implementations results from the substantially similar masses of the debris cloud and the original fusion target. For debris clouds having a mass within an order of magnitude of the fusion target, the velocities are within an order of magnitude due to conservation of momentum.

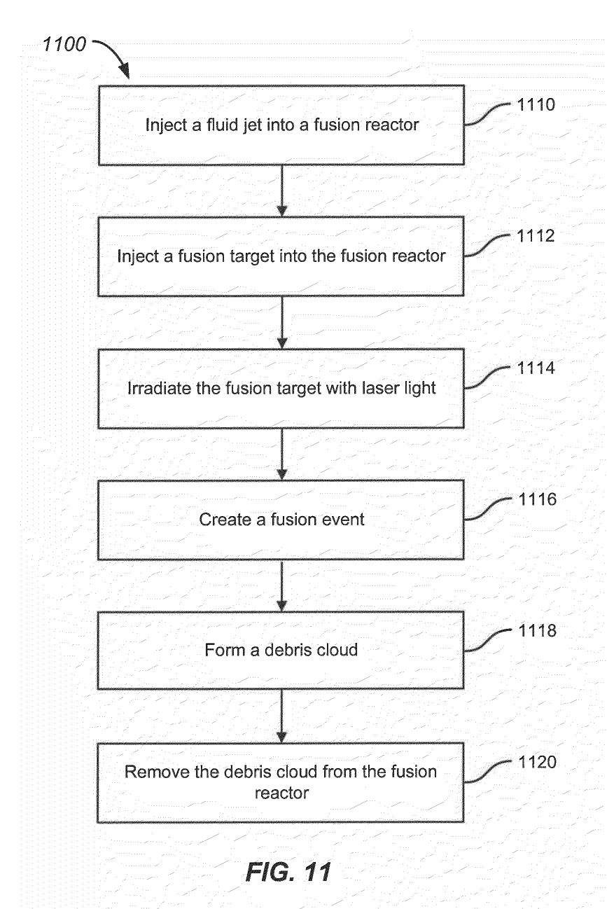

FIG. 11 is a simplified flowchart illustrating a method of removing a debris cloud from a fusion reactor according to another embodiment of the present invention. The method illustrated in FIG. 11 is referred to as forced advection since the fluid jet provides a motive force to the debris cloud. The method 1100 includes injecting a fluid jet into the fusion reactor at a first velocity (1110) and thereafter injecting a fusion target into the fusion reactor at a second velocity (1112). The fusion reactor can also be referred to as a fusion reaction chamber. In some embodiments, the second velocity is greater than the first velocity. Additionally, in some embodiments, the path of the fluid jet and the path of the fusion target are collinear. As described more fully throughout the present specification, injecting the fusion target into the fusion reactor can include immersing the fusion target in the fluid jet so that the conductive heating of the fusion target by the gas present in the fusion reactor is reduced as a result of reductions in the heat transfer coefficient as well as the temperature difference between the fusion target and its immediate surroundings.

The method also includes irradiating the fusion target with laser light (1114) and creating a fusion event (1116). The fusion event results in the formation of a debris cloud in a vicinity of the fusion event (1118) and removing the debris cloud from the fusion reactor (1120). The fluid jet applies a motive force to the debris cloud and the velocity of removal is approximately equal to a velocity of the fluid jet in some implementations. In some implementations, the fusion target exits the fluid jet prior to being irradiated with the laser light.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of advecting a debris cloud from a fusion reactor, the method comprising:
injecting a fusion target into the fusion reactor at a predetermined velocity;
irradiating the fusion target with laser light;
creating a fusion event;
forming a debris cloud in a vicinity of the fusion event; and
advecting the debris cloud from the fusion reactor at a velocity approximately equal to the predetermined velocity.

2. The method of claim 1 wherein the fusion target comprises a hohlraum containing fusion fuel.

3. The method of claim 2 wherein the hohlraum is rifled.

4. The method of claim 1 wherein the predetermined velocity ranges from about 100 m/s to about 300 m/s.

5. The method of claim 1 wherein the debris cloud is characterized by a diameter of less than 100 cm.

6. The method of claim 5 wherein the diameter is less than 50 cm.

7. The method of claim 1 wherein the velocity approximately equal to the predetermined velocity is less than the predetermined velocity.

8. The method of claim 7 wherein the velocity approximately equal to the predetermined velocity is between about 25% and 50% of the predetermined velocity.

9. A method of removing a debris cloud from a fusion reactor, the method comprising:
injecting a fluid jet into the fusion reactor at a first velocity;
thereafter, injecting a fusion target into the fusion reactor at a second velocity;
irradiating the fusion target with laser light;
creating a fusion event;
forming a debris cloud in a vicinity of the fusion event; and
removing the debris cloud from the fusion reactor, wherein the fluid jet applies a motive force to the debris cloud.

10. The method of claim 9 wherein the second velocity is greater than the first velocity.

11. The method of claim 9 wherein a path of the fluid jet and a path of the fusion target are collinear.

12. The method of claim 9 wherein a velocity of removal is approximately equal to a velocity of the fluid jet.

13. The method of claim 9 wherein injecting the fusion target into the fusion reactor comprises immersing the fusion target in the fluid jet.

14. The method of claim 13 wherein the fusion target exits the fluid jet prior to irradiating the fusion target with laser light.

15. A fusion reaction system comprising:
a fusion reaction chamber including laser ports, an injection port, and an exit port;
a fusion target injection system operable to launch a fusion target into the fusion reaction chamber through the injection port;
a laser system operable to direct laser beams into the fusion reaction chamber through the laser ports; and
a fusion region disposed inside the fusion reaction chamber and operable to support a fusion event, wherein a debris cloud produced by the fusion event exits the fusion reaction chamber through the exit port.

16. The fusion reaction system of claim 15 further comprising:
a fluid jet inlet; and
a fluid jet system operable to inject a fluid jet into the fusion reaction chamber through the fluid jet inlet.

17. The fusion reaction system of claim 16 wherein the fluid jet flows along a path between the fluid jet inlet and the fusion region.

18. The fusion reaction system of claim 15 wherein the fluid jet inlet and the injection port are a same port.

19. The fusion reaction system of claim 15 wherein the fusion reaction chamber is characterized by an environment including a noble gas and the fluid jet comprises the noble gas.

20. The fusion reaction system of claim 19 wherein the noble gas comprises xenon.

21. The fusion reaction system of claim 15 wherein the fluid jet is operable to apply a motive force to the debris cloud.
